(19) United States
(12) Patent Application Publication
(10) Pub. No.: US 2013/0000900 A1
(43) Pub. Date: Jan. 3, 2013

(54) DOWN-HOLE PLACEMENT OF WATER-SWELLABLE POLYMERS

(75) Inventors: Rajendra A. Kalgaonkar, Pune (IN); Anupom Sabhapondit, Pune (IN); Antony Stephen Aldridge, Houston, TX (US)

(73) Assignee: Halliburton Energy Services, Inc.

(21) Appl. No.: 13/175,465

(22) Filed: Jul. 1, 2011

(51) Int. Cl. A47B 43/00; C09K 8/44

(52) U.S. Cl. 166/279; 523/130

(57) ABSTRACT

Methods and fluids are provided for the placement of a water-swellable polymer into a subterranean formation. The methods and fluids include a placement fluid that has an acidic aqueous phase. The water-swellable polymer does not substantially swell in the acidic aqueous phase. The acid is allowed or caused to be spent downhole, whereby the water-swellable polymer can then swell in the formation. In an embodiment, an oil-external emulsion having an internal acidic water phase is provided for placement of a water-swellable polymer into a subterranean formation. Preferably, the oil-external emulsion is adapted to break as the acid contained in the internal water phase is allowed or caused to be spent downhole.

### CROSS-REFERENCE TO RELATED APPLICATIONS

Not applicable.

### BACKGROUND

1. Technical Field

The inventions are in the field of producing crude oil or natural gas. More specifically, the inventions generally relate to methods and compositions for treating a subterranean formation. For example, the methods and compositions can be useful for plugging and sealing the fluid flow through a zone of a subterranean formation.

2. Background Art

Oil & Gas Reservoirs

In the context of production from a well, oil and gas are understood to refer to crude oil and natural gas. These substances are of hydrocarbons that naturally occur in certain subterranean formations. A hydrocarbon is a compound comprising at least hydrogen and carbon. The molecular structure of hydrocarbon compounds can range from being as simple as methane (CH₄) to a large, highly complex compound.

A subterranean formation is a body of rock that has sufficiently distinctive characteristics and is sufficiently continuous for geologists to describe, map, and name it. In the context of formation evaluation, the term refers to the volume of rock seen by a measurement made through a wellbore, as in a log or a well test. These measurements indicate the physical properties of this volume of rock, such as the property of permeability.

A subterranean formation containing oil or gas is sometimes referred to as a reservoir. A reservoir is a subsurface, porous, permeable, or naturally fractured rock body in which oil or gas is stored. The four basic types of hydrocarbon reservoirs are oil, volatile oil, gas condensate, and dry gas.

A reservoir may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Well for Producing Oil and Gas

To produce oil or gas from a reservoir, a well is drilled into a subterranean formation, which may be the reservoir or adjacent to the reservoir. A well includes a wellhead and at least one wellbore from the wellhead penetrating the earth. Typically, a wellbore must be drilled thousands of feet into the earth to reach a hydrocarbon-bearing formation. The greater the depth of the formation, the higher the “static” pressure of the formation. When a reservoir is first discovered, the static pressure equals the initial pressure. After production begins, the static pressure approaches the average reservoir pressure. Usually, but not always, the greater the depth of a formation, the higher the natural “static” temperature of the formation.

The wellbore refers to the drilled hole, including any cased or uncased portions of the well. The borehole usually refers to the inside wellbore wall, that is, the rock face or wall that bounds the drilled hole. A wellbore can have portions that are vertical, horizontal, or anything in between, and it can have portions that are straight, curved, or branched. The wellhead is the surface termination of a wellbore, which surface may be on land or on a seabed. As used herein, “uphole,” “downhole,” and similar terms are relative to the direction of the wellhead, regardless of whether a wellbore portion is vertical or horizontal.

A wellbore can be used as a production wellbore to produce hydrocarbons from the reservoir. A wellbore can be used as an injector well to inject a fluid, e.g., water or gas, to drive the relevant fluids/gasses to a production wellbore.

Broadly, a zone refers to an interval of rock along a wellbore that is differentiated from surrounding rocks based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.”

The near-wellbore region of a zone is usually considered to include the matrix of the rock within a few inches of the borehole. As used herein, the near-wellbore region of a zone is considered to be anywhere within about 12 inches of the wellbore. The far-field region of a zone is usually considered the matrix of the rock that is beyond the near-wellbore region.

Generally, well services include a wide variety of operations that may be performed in oil, gas, geothermal, or water wells, such as drilling, cementing, completion, and intervention. These well services are designed to facilitate or enhance the production of desirable fluids from or through a subterranean formation.

Well Fluids

As used herein, a “well fluid” broadly refers to any fluid adapted to be introduced into a well for any purpose. A well fluid can be, for example, a drilling fluid, a cementing fluid, a treatment fluid, or a spacer fluid. If a well fluid is to be used in a relatively small volume, for example less than about 200 barrels, it is sometimes referred to in the art as a wash, dump, slug, or pill.

As used herein, “into a well” means introduced at least into and through the wellhead. According to various techniques known in the art, equipment, tools, or well fluids can be directed from the wellhead into any desired portion of the wellbore. Additionally, a well fluid can be directed from a portion of the wellbore into the rock matrix of a zone.

Often, the step of delivering a well fluid into a well is within a relatively short period after forming the well fluid, e.g., within one hour. More preferably, the step of delivering the well fluid is immediately after the step of forming the well fluid, which is “on the fly.” It should be understood that the step of delivering the treatment fluid into the wellbore can advantageously include the use of one or more fluid pumps.

Well Treatments and Treatment Fluids

Drilling, completion, and intervention operations can include various types of treatments that are commonly performed in a wellbore or subterranean formation. For example, a treatment for fluid-loss control can be used during any of drilling, completion, and intervention operations. During completion or intervention, stimulation is a type of treatment performed to enhance or restore the productivity of oil and gas from a well. Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Other types of completion or intervention treatments can include, for example, gravel packing, consolidation, and controlling excessive water production.

As used herein, the word “treatment” refers to any treatment for changing a condition of a wellbore or an adjacent subterranean formation. Examples of treatments include fluid-loss control, isolation, stimulation, or conformance control; however, the word “treatment” does not necessarily imply any particular treatment purpose.

A treatment usually involves introducing a treatment fluid into a well. As used herein, a “treatment fluid” is a fluid used in a treatment. Unless the context otherwise requires, the word “treatment” in the term “treatment fluid” does not necessarily imply any particular treatment or action by the fluid. If a treatment fluid is to be used in a relatively small volume, for example less than about 200 barrels, it is sometimes referred to in the art as a wash, dump, slug, or pill.

As used herein, a “treatment zone” refers to an interval of rock along a wellbore into which a treatment fluid is directed to flow from the wellbore. Further, as used herein, “into a treatment zone” means into and through the wellhead and, additionally, through the wellbore and into the treatment zone.

Improving Oil/Water Ratio during Production (“Conformance Control”)

There has been a continuing and long-felt need for improving the oil/water ratio during hydrocarbon production by using chemical gel systems to resist the flow of injected or natural aqueous drive fluid through high permeability channels and fractures. This is sometimes referred to in the art as “conformance control.” The general approach has been to inject a mixture of reagents, initially low in viscosity, into a zone of the formation that has high permeability. After a sufficient time to allow the mixture to be pumped into the subterranean formation or when exposed to the elevated temperature of the formation, the mixture of reagents then forms a gel to block the flow of water. Several mixtures of reagents have been used in this way.

For example, U.S. Pat. No. 4,600,057 entitled “Method of Reducing the Permeability of a Subterranean Formation” issued Jul. 15, 1986, and having named inventor John K. Borchardt, discloses a method of reducing the permeability of a subterranean formation comprising contacting the formation with an aqueous polymerizable composition comprising a polymerization monomer, a polymerization catalyst having a latent period, and an alcoholic compound selected from the group consisting of a cyclic ether containing a hydroxymethylene substituent on a carbon atom bonded to the ether oxygen, an aliphatic alcohol having a carbon-to-carbon double bond or a carbon-to-carbon triple bond, and mixtures thereof. See Abstract. U.S. Pat. No. 4,600,057 is incorporated herein by reference in its entirety.

U.S. Pat. No. 4,640,361 entitled “Thermally Responsive Aqueous Silicate Mixtures and Use Thereof” issued Feb. 3, 1987, and having named inventors William H. Smith and Edward F. Vinson, discloses a thermally responsive aqueous silicate composition consisting essentially of an aqueous solution containing an alkali metal silicate and a thermally responsive silicate gelation activator. The thermally responsive silicate gelation activator is a reducing sugar selected from the group consisting of lactose, dextrose, fructose, galactose, mannose, maltose, xylose and mixtures thereof. The aqueous silicate composition can be utilized in treating a subterranean formation for the purpose of sealing the formation. See Abstract. U.S. Pat. No. 4,640,361 is incorporated herein by reference in its entirety.

U.S. Pat. No. 5,168,928 entitled “Preparation and Use of Gelable Silicate Solutions in Oil Field Applications” issued Dec. 8, 1992, and having named inventors Dralen T. Terry and Edward F. Vinson, discloses a gelable silicate solution prepared by mixing fumed silica and an alkali metal hydroxide with water. The silicate solution is used to form a seal or plug in one or more subterranean formations or in a well bore penetrating the formations by pumping the solution into a desired location in the well bore or formations and allowing the silicate solution to gel therein. See Abstract. U.S. Pat. No. 5,168,928 is incorporated herein by reference in its entirety.

U.S. Pat. No. 5,320,171 entitled “Method of Preventing Gas Coning and Fingering in a High Temperature Hydrocarbon Bearing Formation” issued Jun. 14, 1994, and having named inventor Mary A. H. Laramay, discloses a method of preventing gas coning or fingering from a gas cap in an oil producing well. A silicate solution and a delayed activator are injected into the gas cap under conditions such that the activator causes the silicate to gel after a predetermined period of time to form a substantially impermeable zone or layer above the oil bearing formation to prevent gas from flowing into the oil well during production. See Abstract. U.S. Pat. No. 5,320,171 is incorporated herein by reference in its entirety.

U.S. Pat. No. 5,335,726 entitled “Water Control” issued Aug. 9, 1994, and having named inventor Klein A. Rodrigues, discloses a method of forming a gel in a subsurface formation whereby a monomer is polymerized in the formation in the presence of a crosslinker by an initiator selected from azo compounds which are temperature activated over a range of temperatures. The method is particularly useful to substantially terminate or at least decrease the flow of water from a subterranean formation into a wellbore penetrating the formation. See Abstract. U.S. Pat. No. 5,335,726 is incorporated herein by reference in its entirety.

U.S. Pat. No. 5,358,051 entitled “Method of Water Control with Hydroxy Unsaturated Carbonyls” issued Oct. 25, 1994, and having named inventor Klein A. Rodrigues, discloses a method of forming a gel in the subsurface formation whereby a self crosslinking monomer selected from hydroxy unsaturated carbonyl compounds is polymerized in the formation by a suitable initiator. In a preferred embodiment, the initiator is selected from azo compounds which are temperature activated over a range of temperatures. The method is particularly useful to substantially terminate or at least decrease the flow of water from a subterranean formation into a wellbore penetrating the formation. See Abstract. U.S. Pat. No. 5,358,051 is incorporated herein by reference in its entirety. Without being limited by theory, it is now believed that the monomer is not self-crosslinking, rather, it is the difunctional monomeric by-product that causes the crosslinking,

U.S. Pat. No. 5,836,392 entitled “Oil And Gas Field Chemicals” issued Nov. 17, 1998, and having named inventor Phillip Lance Urlwin-Smith, discloses a method for conformance control of a reservoir comprising injecting into a zone of the reservoir an aqueous solution of a co-polymer comprising at least one ethylenically unsaturated polar monomer and at least one copolymerizable ethylenically unsaturated ester formed from a hydroxy compound of the formula ROH wherein R is a selected alkyl group, alkenyl group, cycloalkyl group, aryl group or such groups substituted with from 1 to 3 hydroxy, ether or thio ether groups or a heterocyclic or selected heterocyclic alkylene group and at least one heteroatom selected from oxygen, nitrogen and sulfur and a selected alkenoic or aralkenoic carboxylic acid or sulfonic or phosphoric acid together with a crosslinking agent comprising a multi-valent metal ion capable of crosslinking an acrylic acid polymer to form a viscous gel. The injected fluid is flowed through at least a portion of a high permeability region within said zone wherein it is heated to an elevated temperature whereupon crosslinking of the polymers occurs to form a substantially non-flowable gel within said high permeability region. The crosslinking of the injected fluid to form the non-flowable gel within the formation reduces the permeability of said region in said zone. See Abstract. U.S. Pat. No. 5,836,392 is incorporated herein by reference in its entirety.

U.S. Pat. No. 6,187,839 entitled “Methods of Sealing Compositions and Methods” issued Feb. 13, 2001, and having named inventors Larry Eoff and David Brown, provides methods of sealing subterranean zones using high density sealing compositions. The methods are basically comprised of introducing a sealing composition into the subterranean zone comprised of a high density aqueous salt solution, a polymerizable monomer and a polymerizable initiator and allowing said sealing composition to form a sealing gel in said zone. See Abstract. U.S. Pat. No. 6,187,839 is incorporated herein by reference in its entirety.

U.S. Pat. No. 6,192,986 entitled “Blocking Composition For Use In Subterranean Formation,” issued Feb. 27, 2001, and having named inventor Phillip Lance Urlwin-Smith, discloses a polymer composition for pumping downhole to gel in a subterranean formation comprising a water-soluble copolymer of (i) at least one non-acidic ethylenically unsaturated polar monomer and (ii) at least one copolymerisable ethylenically unsaturated ester; and an organic gelling agent therefor. See Abstract. U.S. Pat. No. 6,192,986 is incorporated herein by reference in its entirety.

U.S. Pat. No. 7,128,148, entitled “Well Treatment Fluid and Methods for Blocking Permeability of a Subterranean Zone,” filed Apr. 16, 2004, issued on Oct. 31, 2006, discloses a well treatment fluid for use in a well, the well treatment fluid comprising water, a water-soluble polymer comprising at least one unit of vinyl amine, and an organic compound that is crosslinked with the polymer. It also discloses a method of treating a subterranean formation penetrated by a wellbore, the method comprising the steps of: (a) forming a treatment fluid comprising water, a water-soluble polymer comprising at least one unit of vinyl amine, and an organic compound that is crosslinked with the polymer; and (b) introducing the treatment fluid through the wellbore and into contact with the formation. See Abstract. U.S. Pat. No. 7,128,148 is herein incorporated by reference in its entirety.

The above compositions, however, often experience such a long delay in developing high viscosity that the composition are excessively diluted and displaced more deeply into the formation than desired. Consequently, the compositions may pass completely through highly permeable fractures, vugs, and the like, instead of blocking them.

Water-Swellable Polymers for Conformance Control

Another method for controlling the production of natural and injection fluid in subterranean formations includes the use of water-swellable polymers. For example, water-swellable polymers are disclosed in U.S. Pat. No. 6,889,766, filed Feb. 27, 2003, issued May 10, 2005, entitled, “Methods For Passing A Swelling Agent Into A Reservoir To Block Undesirable Flow Paths During Oil Production,” which is incorporated by reference in its entirety. Such water-swellable polymers possess the capacity to form gel masses that resist unwanted fluid flow through the formation. The resultant gel masses readily penetrate into fractures of a subterranean formation if the gel masses are of a suitable size. The size of the resultant gel masses depends on the particle size of the dry polymeric material prior to hydration. These properties allow the gelled polymer particles to be packed into the formation voids, forming a seal within the formation.

U.S. Pat. No. 7,287,586 entitled “Compositions and Methods for Plugging and Sealing a Subterranean Formation” issued Oct. 30, 2007, and having named inventors Don M. Everett, Larry S. Eoff, and Eldon D. Dalrymple, discloses a composition for treating a subterranean formation, the composition comprising a water-swellable agent and a sealing agent. Preferably, the water-swellable agent: (i) absorbs greater than 100 weight % of water; and (ii) swells to greater than 100 weight % as it absorbs water. Preferably the sealing agent: (i) is greater than 0.01 weight % soluble in water; and (ii) forms a three dimensional gel structure in water. Also provided is a method of treating a subterranean formation penetrated by a wellbore, the method comprising the steps of: (a) introducing a sealing agent into the subterranean formation; and (b) introducing a water-swellable agent into the subterranean formation. See Abstract. U.S. Pat. No. 7,287,586 is incorporated herein by reference in its entirety.

Water-swellable polymers can be pumped in brine and swelling can be delayed by increasing the salt concentration. However, this reduces the ultimate swelling of the particles of the water-swellable polymer and it could still be a problem if pump times are long.

Water-swellable polymers can be pumped in an oil carrier to prevent premature swelling, but then contact with water must be assured if they are to swell in the formation. This is not guaranteed. Using a hydrocarbon-based carrier fluid, such as diesel, it would be difficult to expose the water-swellable polymer to water if it does not form a bridge in a fracture, vug, or other space in the formation.

The placement of water-swellable polymers has been a continuing challenge.

### SUMMARY OF THE INVENTION

Methods and fluids are provided for the placement of a water-swellable polymer into a zone of a subterranean formation. The methods and fluids include a placement fluid that has an acidic aqueous phase. The water-swellable polymer is selected for having the property of not substantially swelling in an acidic aqueous phase. The acid of the acidic aqueous phase is allowed or caused to be spent downhole, whereby the water-swellable polymer can swell in the formation.

In an embodiment of using an acidic aqueous fluid, the method can include the steps of: (a) introducing into the zone of the subterranean formation a fluid comprising: (i) a water-swellable polymer, wherein the water-swellable polymer is selected for not substantially swelling in an aqueous phase having a sufficiently acidic pH; and (ii) an aqueous phase, wherein the aqueous phase comprises acid to make the pH equal to or less than the sufficiently acidic pH; and (b) allowing or causing the acid to be spent in the formation such that the pH of the aqueous phase becomes greater than the sufficiently acidic pH.

In another embodiment, an oil-external emulsion having an internal acidic phase provides efficient placement of a water-swellable polymer into the reservoir for down-hole applications, such as conformance control. Preferably, the oil-external emulsion is adapted to break as the acidic internal phase is allowed or caused to be spent downhole. The method can include the steps of: (a) introducing a water-in-oil emulsion into the zone of the formation, wherein the emulsion includes: (i) an external oil phase; (ii) a water-swellable polymer, wherein the water-swellable polymer is selected for not substantially swelling in an aqueous phase having a sufficiently acidic pH; and (iii) an internal aqueous phase, wherein the aqueous phase comprises acid to make the pH equal to or less than the sufficiently acidic pH; and (iv) an emulsifier; wherein the water-in-oil emulsion is at least sufficiently stable under the conditions of introducing to reach the subterranean formation before breaking; and (b) allowing or causing the acid to be spent in the formation such that the pH of the aqueous phase becomes greater than the sufficiently acidic pH. This can break the emulsion and allow the water-swellable polymer to swell.

In yet another embodiment, a fluid for placing a water-swellable polymer into a subterranean formation is provided. The fluid includes: (i) an external oil phase; (ii) a water-swellable polymer, wherein the water-swellable polymer is selected for not substantially swelling in an aqueous phase having a sufficiently acidic pH; and (iii) an internal aqueous phase, wherein the aqueous phase comprises acid to make the pH equal to or less than the sufficiently acidic pH; and (iv) an emulsifier.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS AND BEST MODE

### General Definitions and Usages

As used herein, the words “comprise,” “have,” “include,” and all grammatical variations thereof are each intended to have an open, non-limiting meaning that does not exclude additional elements or steps.

As used herein, if not otherwise specifically stated, the physical state or phase of a substance (or mixture of substances) and other physical properties are determined at a temperature of 77° F. (25° C.) and a pressure of 1 atmosphere (Standard Laboratory Conditions).

As used herein, if not otherwise specifically stated, a substance is considered to be “soluble” in a liquid if at least 10 grams of the substance can be dissolved in one liter of the liquid when tested at 77° F. and 1 atmosphere pressure for 2 hours and considered to be “insoluble” if less soluble than this.

As will be appreciated by a person of skill in the art, the hydratability, dispersability, or solubility of a substance in water can be dependent on the salinity, pH, or other substances in the water. Accordingly, the source, salinity, pH, and additive selection of the water can be modified to facilitate the hydratability, dispersability, or solubility of a substance in aqueous solution.

Unless otherwise specified, as used herein the apparent viscosity of a fluid (excluding any suspended solid particulate larger than silt) is measured with a Fann Model 50 type viscometer at a shear rate of 40 l/s and at 77° F. (25° C.) and a pressure of 1 atmosphere. For reference, the viscosity of pure water is about 1 cP.

As used herein, a substance is considered to be a fluid if it has an apparent viscosity less than 5,000 cP (independent of any gel characteristic).

In the oil industry, the term “gel” is used broadly to refer to a fluid viscosified with a thickening or gelling agent, regardless of whether it meets the technical definition for the physical state of a gel. As used herein, unless the context otherwise requires, a substance referred to as a “gel” is subsumed by the concept of “fluid” if it is a pumpable fluid.

Unless otherwise specified, any ratio or percentage means by weight.

As used herein, the phrase “by weight of the water” means the weight of the water of the continuous phase of the fluid without the weight of any proppant, viscosity-increasing agent, dissolved salt, or other materials or additives that may be present in the water.

Unless otherwise specified, any doubt regarding whether units are in U.S. or Imperial units, where there is any difference, U.S. units are intended herein. For example, “gal/Mgal” means U.S. gallons per thousand U.S. gallons.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified a number of different ways, including based on the size of the dispersed particles, the uniformity or lack of uniformity of the dispersion, whether or not precipitation occurs, and the presence of Brownian motion. For example, a dispersion can be considered to be homogeneous or heterogeneous based on being a solution or not, and if not a solution, based on the size of the dispersed particles (which can refer to droplet size in the case of a dispersed liquid phase).

Fluids and Apparent Viscosity

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables; nevertheless, as used herein, a fluid does not refer to a continuous mass of particulate. The sizes of the solid particles of a mass of a particulate are too large to be appreciably affected by the range of Intermolecular Forces.)

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

Every fluid inherently has a continuous phase. As used herein, “water-based” regarding a fluid means that water or an aqueous solution is the dominant material by weight of the continuous phase of the substance. In contrast, “oil-based” means that oil is the dominant material by weight of the continuous phase of the substance.

Emulsions

An emulsion is a fluid including a dispersion of immiscible liquid particles in an external liquid phase. In addition, the proportion of the external and internal phases is above the solubility of either in the other. A chemical (an emulsifier or emulsifying agent) can be included to reduce the interfacial tension between the two immiscible liquids to help with stability against coalescing of the internal liquid phase.

An emulsion can be an oil-in-water (o/w) type or water-in-oil (w/o) type. A water-in-oil emulsion is sometimes referred to as an invert emulsion. In the context of an emulsion, a “water phase” refers to a phase of water or an aqueous solution and an “oil phase” refers to a phase of any non-polar organic liquid that is immiscible with water, such as petroleum, kerosene, vegetable oil, or synthetic oil.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

Emulsifiers

As used herein, an “emulsifier” refers to a substance that helps prevent the droplets of the dispersed phase of an emulsion from flocculating or coalescing in the emulsion.

In general, an emulsifier can be or include a cationic, a zwitterionic, or a nonionic emulsifier.

An emulsifier can include a surfactant. The surfactant can be selected from the group consisting of ethoxylated fatty molecules, betaines, glucosides, ethyleneoxide-propylene oxide copolymers, quaternized ethoxylated fatty materials or ethoxylated amines, and any combination thereof in any proportion. Ethoxylated surfactants preferably have a normal distribution of ethylene oxide groups in the range of 10 monomer units-200 monomer units. More preferably, the length of the ethylene oxide portion of the nonionic surfactant has a normal distribution in the range of 20 monomer units-50 monomer units. For example, an emulsion can also contain a co-emulsifier such as poly(vinyl alcohol) or pluronic or tetronic surfactant that may be used in conjunction with the surfactants mentioned above.

An emulsion can also include other additives. For example, the emulsion can contain a freezing-point depressant. More preferably, the freezing point depressant is for the water of the continuous phase. Preferably, the freezing-point depressant is selected from the group consisting of water-soluble ionic salts, alcohols, glycols, urea, and any combination thereof in any proportion.

Breaking an Emulsion

As used herein, to “break,” in regard to an emulsion, means to cause the creaming and coalescence of emulsified drops of the internal dispersed phase so that the internal phase separates out of the external phase. Breaking an emulsion can be accomplished mechanically (for example, in settlers, cyclones, or centrifuges) or with chemical additives to increase the surface tension of the internal droplets.

Gels and Deformation

A gel is formed by a network of interconnected molecules, such as a crosslinked polymer or of micelles. The network gives a gel phase its structure and an apparent yield point. A gel may or may not have stickiness (tack). At the molecular level, a gel is a dispersion in which the network of molecules is continuous and the liquid is also continuous. A gel can be considered to be a single phase.

Technically, a gel is a semi-solid, jelly-like state or phase that can have properties ranging from soft and weak to hard and tough. Shearing stresses below a certain finite value fail to produce permanent deformation. The minimum shear stress which will produce permanent deformation is known as the shear or gel strength of the gel.

### DETAILED DESCRIPTION

In an embodiment, an acidic water phase is useful for efficient placement of a water-swellable polymer for treating a subterranean formation. The water-swellable polymer is selected for having negligible swelling under acidic pH. However, as the pH of the water increases towards neutral, the water-swellable polymer swells at least 2 times its original weight, more preferably at least 10 times its original weight, and most preferably at least 100 times its original weight.

As the acid of the aqueous phase comes into contact with a subterranean formation, the acid will start reacting with the formation thereby increasing the pH of the water phase of the emulsion. This is expected to raise the pH of the water, allowing for the swelling of the water-swellable polymer.

In an embodiment of using an acidic aqueous fluid, the method includes the steps of: (a) introducing a fluid comprising: (i) a water-swellable polymer, wherein the water-swellable polymer is selected for not substantially swelling in an aqueous phase having a sufficiently acidic pH; and (ii) an aqueous phase, wherein the aqueous phase comprises acid to make the pH equal to or less than the sufficiently acidic pH; and (b) allowing or causing the acid to be spent in the formation such that the pH of the aqueous phase becomes greater than the sufficiently acidic pH. The water-swellable polymer is carried in the aqueous phase. The fluid can preferably further include a sealing agent.

The acidic aqueous phase allows more efficient placement of the water-swellable polymer into the formation. The use of the acidic aqueous phase avoids premature swelling of the water-swellable polymer.

### Water-Swellable Agents

The term “water-swellable” is generally used to refer to an agent that is capable of swelling in the presence of water. As used herein, the term is specifically defined to mean an agent that swells (i.e., expands) as it absorbs water to at least two (2) times its original mass. Preferably, the water-swellable agent: (i) absorbs greater than 10 times its weight of water; and (ii) swells to greater than 10 times its original volume as it absorbs water. Preferably, the water-swellable agent has these properties of absorbing and swelling at standard temperature and pressure. Preferably, the water-swellable agent is insoluble in water.

Without being limited by any theoretical explanation, it is believed that because the water-swellable agent is so insoluble in water, it does not become diluted and washed away by water or other aqueous injectants flowing through the formation.

Preferably the water-swellable agent is a polymer. Examples of polymeric water-swellable polymers include crosslinked polyacrylamide, crosslinked polyacrylate, copolymers of acrylamide and acrylate monomers, a starch backbone grafted with acrylonitrile and acrylate, polymers of two or more of allylsulfonate, 2-acrylamido-2-methyl-1-propanesulfonic acid, 3-allyloxy-2-hydroxy-1-propane-sulfonic acid, acrylamide, and acrylic acid monomers, and any combination in any proportion of the foregoing. The water-swellable polymer is preferably a crystalline polymer that has been dehydrated. One preferred water-swellable polymer is crosslinked polyacrylamide in the form of a hard crystal. Still other examples of water-swellable polymers include hydrolyzed polyacrylonitrile, carboxyalkyl cellulose, carboxymethyl starch, salts of carboxymethyl cellulose, carboxyalkyl polysaccharide, and any combination in any proportion of the foregoing. Further water-swellable polymers are described in European Patent No. 0566118, filed Apr. 14, 1993, having for named inventor Jian Qin, which is related to issued U.S. Pat. No. 5,550,189, issued Aug. 27, 1996, incorporated herein by reference in its entirety.

Preferably, the water-swellable polymer comprises a superabsorbent. Superabsorbents are swellable crosslinked polymers that have the ability to absorb and store at least multiples of their own weight of aqueous liquids by forming a gel. Superabsorbents retain the water that they absorb and typically do not release the water, even under pressure. Examples of superabsorbents are sodium acrylate-based polymers having three dimensional, network-like molecular structures. The polymer chains are formed by the reaction/joining of units of acrylic acid monomer, which have been substantially neutralized with sodium hydroxide (caustic soda). Crosslinking units of acrylic acid monomer form a three-dimensional network, enabling the superabsorbent to absorb water into the spaces in the three-dimensional network, and thus forming a gel and locking up water.

Preferably, as the water-swellable polymer absorbs water, its physical volume increases by about 10 to 400 times its original volume. The amount and rate by which the water-swellable polymer increases in volume can vary depending upon temperature, grain size, and the ionic strength of the carrier fluid. Because the temperature of a well generally increases from top to bottom, the rate of swelling tends to increase as the water-swellable agent is pumped downhole. The rate of swelling also increases as the grain size of the water-swellable polymer decreases and as the ionic strength of the carrier fluid decreases. For example, the size of the crosslinked polyacrylamide polymer in a 14 mm grain size increases by 0% in 20 minutes after contacting water, 150% in 35 minutes after contacting water, and 400% in 45 minutes after contacting water at 80° F. The size of the crosslinked polyacrylamide polymer increases by 0% in 15 minutes after contacting water, 200% in 25 minutes after contacting water, and 400% in 35 minutes after contacting water at 145° F. The mass of the crosslinked polyacrylamide polymer increases by 0% in 45 minutes after contacting 9.2 pounds/gallon (ppg) Brine Water, 25% in 60 minutes after contacting 9.2 ppg Brine Water, and 50% in 75 minutes after contacting 9.2 ppg Brine Water at 80° F. The mass of the crosslinked polyacrylamide polymer increases by 0% in 30 minutes after contacting 9.2 ppg Brine Water, 25% in 45 minutes after contacting 9.2 ppg Brine Water, and 50% in 60 minutes after contacting 9.2 ppg Brine Water at 145° F. Other scientific data regarding swellable polymers is illustrated in U.S. Pat. No. 6,889,766, filed Feb. 27, 2003, issued May 10, 2005; U.S. Pat. No. 7,866,394, filed Feb. 27, 2003, issued Jan. 1, 2011; and U.S. Pat. No. 6,936,574, issued Aug. 30, 2005; each of which is incorporated herein by reference in its entirety.

While downhole, the water-swellable polymer begins to absorb the water and swell into a gel mass that is substantially resistant to the flow of fluid, diminishing the flow into/through the fractures, vugs, voids, fissures, and high permeability streaks through which aqueous fluids could otherwise pass unrestricted. The gel mass can withstand a relatively large amount of pressure and thus resists being dislodged from its position during subsequent placement of the sealant.

Water-Swellable Polymer Selected for Not Swelling in Acidic Solution

The water-swellable polymer is selected for not swelling in an acidic solution by more than 15% of its potential swelling volume in water having a neutral pH. Preferably, the water-swellable polymer is selected for not swelling in an acidic solution by more than 10% of its potential swelling volume in water having a neutral pH. As used herein the test for not swelling at a particular pH is upon standing for one hour at a temperature of 200° F. Of course, it can be useful if the water-swellable polymer does not substantially swell in a sufficiently acidic pH for a longer time or at higher temperature.

The sufficiently acidic pH to prevent a water-swellable polymer from substantially swelling is expected to depend on the particular water-swellable polymer. In general, the sufficiently acidic pH is expected to be a pH of equal to or less than 4.5. More commonly, the sufficiently acidic pH is expected to be equal to or less than 4.0. More commonly still, the sufficiently acidic pH is expected to be equal to or less than 2.0.

Acidic Aqueous Phase

The water of the acidic phase can be of any convenient source. Preferably, the water does not have any component that would interfere with the chemistry of swelling of the water-swellable polymer, the chemistry of the breaking the emulsion if an emulsion is used, the intended use of the water-swellable polymer, or the use of the fluid after breaking. For example, the water can be fresh water, seawater, or brine. Preferably, the water is selected to be compatible with the water-swellable polymer.

Preferably, the acid concentration is in the range of about 0.01% to about 30% by volume of the water. The acid can be of any convenient type, including organic or inorganic, effective for making the water sufficiently acidic to prevent substantial swelling of the water-swellable polymer employed. Preferably, the acid and concentration is selected such that the pH is equal to or less than 4.5. More preferably, the pH is equal to or less than 4.0. Most preferably, the pH is equal to or less than 2.0.

Sealing Agent for Water-Swellable Polymers

Preferably, the water-swellable polymer is used with a sealing agent.

As used herein, the term “sealing agent” is generally used to refer to an agent that is initially capable of being pumped in a fluid but after a period of time can form a gel that is not pumpable. This term does not necessarily require, however, that the sealing agent form a gel that completely “seals” a porous formation, but after gelling, the agent should at least resist the fluid flow through a porous formation.

Preferably the sealing agent: (i) is greater than 0.01 weight % soluble in water; and (ii) forms a three dimensional gel structure in water. Also, the sealing agent preferably has these properties of solubility at standard temperature and pressure.

The sealing agent is a composition of one or more chemical compounds or classes of chemical compounds that can react, for example, by polymerization or crosslinking, to form a material that gels with water. Optionally, the sealing agent can include a catalytic agent to promote polymerization or crosslinking, or a catalytic agent can be added later, for example, by over flushing the sealing agent with a carrier containing the catalytic agent.

The reaction of the sealing agent can be delayed to allow for pumping the sealing agent through a wellbore and into a subterranean formation. As the temperature of a subterranean formation is elevated, the increase in temperature can also promote polymerization or crosslinking. For example, some crosslinking systems are considered to be heat activated.

Examples of sealing agents have been incorporated by reference in the above Background of the Invention. Preferably, the sealing agent comprises a polymerizable monomer. More preferably, the sealing agent comprises a polymerizable monomer and a crosslinker for the polymerizable monomer. Preferably, the polymerizable monomer comprises a water soluble, hydroxy unsaturated carbonyl monomer. In an embodiment, the sealing agent comprises: polymerizable water-soluble vinyl monomer; multifunctional vinyl monomer capable of polymerizing and crosslinking; and a water-soluble azo initiator.

Hard Crystal and Sealing Agent

Without being limited by any theoretical explanation, in a preferred embodiment of a water-swellable polymer including or being a crosslinked polyacrylamide in the form of a hard crystal, it is believed that the crosslinked polyacrylamide deflects and surrounds the water molecules during water absorption. In effect, as the crosslinked polyacrylamide absorbs water, the crosslinked polyacrylamide undergoes a change from that of a dehydrated crystal to that of a hydrated gel. In combination with a sealing agent, it is believed that some of the sealant is adsorbed by the crosslinked polyacrylamide (water-swellable polymer) within their individual three dimensional lattice structures, and thus when the sealant crosslinks or polymerizes, the newly formed gel is a continuous mass both inside and outside the water-swellable polymer, thereby providing a more cohesive gel mass. In addition, it is believed that the sealing agent becomes a more concentrated gel mass, and is better able to “seal” against the formation surface. It is further believed that the water-swellable crosslinked polyacrylamide becomes more pressure resistant in conjunction with the sealing agent because it acquires a more sticky property. Similarly, the sealing agent becomes more pressure resistant because it acquires the voluminous properties of a water-swellable polymer. Because of this synergistic relationship, the water-swellable polymer and the sealing agent form a more durable seal in a subterranean formation.

Once fully hydrated, the water-swellable polymer and the sealing agent exhibit a high resistance to the migration of aqueous fluids through the gel mass. That is, the polymers of the water-swellable polymer and the sealing agent are sufficiently packed together to substantially inhibit water from passing through the gel. Further, the gel can effectively seal fractures in the reservoir because it can withstand substantial amounts of pressure without being dislodged from the formation's surface. The relatively low permeability of water or other injectant fluids through the gel-packed formation creates a barrier to the flow of water through the permeable zone in the subterranean formation.

Water-in-Oil Emulsion

In another embodiment, an oil-external emulsion, an acidic internal water phase, and an emulsifier, are useful for efficient placement of a water-swellable polymer for treating a subterranean formation. The emulsion is adapted to be stable with the internal phase having an acidic pH of equal to or less than 4.5. Preferably, the emulsion is adapted to be stable with the internal phase having an acidic pH of equal to or less than 4.

In some embodiments of the emulsion, the emulsion can contain up to about 400 lb/Mgal of the water-swellable polymer without affecting the stability of the emulsion.

As the emulsion comes in contact with the formation, the acid of the internal phase will start reacting with the formation thereby increasing the pH of the water phase of the emulsion. This will raise the pH, leading to the emulsion breaking and swelling of the water-swellable polymer.

This water-in-oil emulsion gives control over placement of the water-swellable polymer by avoiding its premature swelling.

This water-in-oil emulsion allows more efficient placement of the water-swellable polymer into the formation. The use of this emulsion avoids premature swelling of the water-swellable polymer as may be the case when brine is used as the carrier fluid. This emulsion gives more control over the swell performance of the polymer. This emulsion system would be considerably lower in cost as compared to conventional diesel or brine based carrier fluids. Overall, an increase in job success is expected.

In an embodiment of using a water-in-oil emulsion with an acidic internal phase, the method includes the steps of: (a) introducing a water-in-oil emulsion into the formation, wherein the emulsion includes: (i) an external oil phase; (ii) a water-swellable polymer, wherein the water-swellable polymer is selected for not substantially swelling in an aqueous phase having a sufficiently acidic pH; and (iii) an internal aqueous phase, wherein the aqueous phase comprises acid to make the pH equal to or less than the sufficiently acidic pH; and (iv) an emulsifier; wherein the water-in-oil emulsion is at least sufficiently stable under the conditions of introducing to reach the subterranean formation before breaking; and (b) allowing or causing the acid to be spent in the formation such that the pH of the aqueous phase becomes greater than the sufficiently acidic pH.

External Oil Phase

The external oil phase of the emulsion can include any non-polar organic liquid that is immiscible with water, such as petroleum, diesel, kerosene, vegetable oil, or synthetic oil.

Internal Acidic Phase

Preferably, the internal acidic phase with the water-swellable polymer is in the range of about 5% to about 75% by volume of the water-in-oil emulsion.

Emulsifier

In an embodiment, the emulsifier is selected for sufficiently stabilizing the internal aqueous phase in the external oil phase under the conditions from the time of formulating the emulsion through introducing the emulsion into a treatment zone of a subterranean formation.

Preferably, the emulsifier can be any of various emulsifying surfactants that can form and stabilize an oil external phase—acidic internal phase emulsion. Examples of suitable emulsifiers include: fatty alkanol amides and a blend of an amphoteric amine salt, a phosphate ester, an ethoxylated dialkyl phenol, a propylene glycol ether, a carboxylic acid terminated polyamide, an electro-neutral fatty ammonium salt of a fatty acid such as, tallow ammonium salt of coco fatty acid, the coco ammonium salt of oleic fatty acid, the coco ammonium salt of coco fatty acid, and similar, or AF-70 additive, AF-61™ emulsifying agent available from Halliburton Energy Services, Oklahoma.

In a preferred embodiment, the emulsifier is in a concentration of about 0.01% to about 5% by volume of the emulsion. More preferably, the emulsifier is present in about 1% to about 3% by volume of the emulsion, and most preferably about 2% by volume of the emulsion.

Emulsion Stability

Preferably, the water-in-oil emulsion is stable, that is, does not break, upon standing for at least one hour at a temperature of at least 200° F. Of course, an emulsion can be adapted to be stable against breaking for a longer time or at higher temperature.

Introducing Step

The fluid is introduced into the formation according to methods well known in the art. If the fluid is an emulsion, the emulsion is preferably adapted to be stable from the time of formulating the emulsion through the time the emulsion is placed in a treatment zone.

Allowing or Causing the Acid to be Spent in the Formation

The acid is allowed or caused to be at least partially spent in the formation. This step can be accomplished, for example, by allowing time for the acid to react with carbonate or similar material present in the formation. If necessary, a delayed-release base can be included in the fluid. According to another embodiment, if helpful, a non-acidic aqueous solution can be introduced before or after introducing the water-swellable polymer into the subterranean formation, which upon mixing with the acidic aqueous phase can dilute the acid or provide additional water for swelling of the water-swellable polymer.

The acidic pH should be allowed or caused to increase to greater than the sufficiently acidic pH that is necessary to prevent substantial swelling of the water-swellable polymer. Preferably, the increase is at least 1.0 pH unit above the sufficiently acidic pH so that swelling then proceeds rapidly when desired. Most preferably, the pH is increased to about neutral. The change in pH can also be used to break a water-in-oil emulsion.

Optional Method Steps

The methods can involve introducing a sealing agent into the subterranean formation and subsequently introducing the water-swellable polymer into the subterranean formation. Alternatively, the water-swellable polymer can be introduced into the subterranean formation prior to introducing the sealing agent into the subterranean formation. Still further, the sealing agent and swelling agent can be introduced into the subterranean formation simultaneously. Also, the sealing agent and water-swellable polymer can be mixed together prior to introducing the mixture into the subterranean formation.

An aqueous solution can be introduced into the subterranean formation before, along with, or after introducing the sealing agent or water-swellable polymer into the subterranean formation. As the aqueous fluid contacts the water-swellable polymer, the water-swellable polymer swells to form a gel mass that substantially plugs one or more of the permeable zones. Preferably, the water-swellable polymer is insoluble in water and thus avoids becoming diluted and washed away by aqueous fluids or subsequent injectants.

According to some embodiments, the water-swellable polymer is incorporated in an effective amount to effectively block or seal a permeable zone upon being placed into the subterranean formation, and the effective amount may vary depending on factors such as the type of the carrier fluid, the size of a fracture, fissure, and the like. The amount of water-swellable polymer that may be combined with the carrier fluid depends on a number of factors, including the type of carrier fluid. In general, the emulsion can contain from about 0.001 to about 5.0 pounds water-swellable polymer/gallon of the emulsion, more preferably from about 0.01 to about 2.0 ppg.

Preferably, an emulsion containing the water-swellable polymer remains sufficiently non-viscous in order to be displaced to the permeable areas of the reservoir. Thus, there is no need to apply higher pressure in an attempt to force the water-swellable polymer into the permeable areas that could damage the rock structure surrounding the reservoir.

The methods or fluids can be used in producing wells or injection wells. The amount of oil production may be monitored to determine if more water-swellable polymer should be added to the reservoir to block additional permeable areas and thus improve production. If needed, additional water-swellable polymer can be introduced into the subterranean formation. This procedure may be repeated until the amount of water-swellable polymer is sufficient to achieve the desired amount of production.

In an embodiment, the water-swellable polymer, preferably with a sealing agent, is introduced into one or more injection wells after termination of the production stage of the primary well. Secondary or tertiary flooding operations may also be performed by displacing one or more injectants into an injection well and through the reservoir to drive additional oil from the reservoir to the production wells. The presence of the fluid in the permeable zones serves to substantially block or seal the flow pathways of the injectants through the permeable zones. The water-swellable polymer and sealing agent may be introduced into the reservoir concurrently with, or preferably prior to the displacing injectants. Advantageously, displacing injectants thus do not prematurely pass through the permeable zones to the production wells before having been introduced through areas of the reservoir-containing oil.

When used in injection applications, the water-swellable polymer in the emulsion can be introduced as it is being pumped into an injection well such that the injectant stream also acts as a carrier fluid for the swelling polymer.

Well Fluid Additives

It should be understood that a well fluid can contain additives that are commonly used in oil field applications, as known to those skilled in the art. These include, but are not necessarily limited to, inorganic water-soluble salts, breaker aids, surfactants, oxygen scavengers, alcohols, scale inhibitors, corrosion inhibitors, fluid-loss additives, oxidizers, water control agents (such as relative permeability modifiers), consolidating agents, proppant flowback control agents, conductivity enhancing agents, and bactericides.

After Treatment, Producing Hydrocarbon from Subterranean Formation

In an embodiment, the methods include: after the step of allowing or causing, flowing back fluid from the well. Preferably, after treatment, the methods include a step of producing hydrocarbon from the subterranean formation is the desirable objective.

If desired, the swollen water-swellable polymer may be removed from the treatment zone after it has been used for its intended purpose. If the water-swellable polymer or sealing agent is a polymer, the backbone structure of the polymer may be broken down such that it becomes more like a liquid. Any known means may be used to break down or collapse the polymer. For example, the polymer may be contacted with an oxidizer such as sodium hypochlorite (i.e., bleach) to eliminate the polymer from the reservoir, preferably by pumping such compounds down the well bore and contacting the conglomerated, swollen water-swellable polymer and sealing agent in situ.

### EXAMPLES

A sample of a crystalline polyacrylamide water-swellable polymer (about 1 mm size particles) was tested in different fluids. One gram of this water-swellable polymer was placed in 250 mL of a fluid for 2 hours. The results are summarized in Table 1.

TABLE 1

| | Weight of | | Volume of | |
|---|---|---|---|---|
| | Water-Swellable | | Water-Swellable | |
| Fluid | Polymer after 2 hours | | Polymer after 2 hours | |
| Tap Water | 115 | grams | 115 | mL |
| 9 ppg NaCl brine | 22 | grams | 20 | mL |
| 1% Formic Acid | 9 | grams | 9 | mL |

As shown in Table 1, this water-swellable material showed negligible swelling in the acidic water.

An example of an water-in-oil emulsion was tested for stability and breaking. The example emulsion included 30% by volume diesel phase, 1% by volume formic acid in 9 ppg NaCl brine, 200 lb/Mgal of the crystalline polyacrylamide water-swellable polymer (about 1 mm size particles), and emulsifier AF70. The emulsion was stable for 1 hour at 200° F. The emulsion would rapidly break upon the addition of sodium carbonate powder to neutralize the pH of the water phase to about 7.0, and the water-swellable polymer would swell.

### CONCLUSION

It should be appreciated that the various elements and steps as disclosed can be combined advantageously or practiced together in various combinations to increase the efficiency and benefits that can be obtained from the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method for treating a zone of subterranean formation, the method comprising the steps of:
(a) introducing into the zone of the formation a fluid comprising:
(i) a water-swellable polymer, wherein the water-swellable polymer is selected for not substantially swelling in an aqueous phase having a sufficiently acidic pH; and
(ii) an aqueous phase, wherein the aqueous phase comprises acid to make the pH equal to or less than the sufficiently acidic pH; and
(b) allowing or causing the acid of the aqueous phase to be spent in the zone of the formation such that the pH of the aqueous phase becomes greater than the sufficiently acidic pH.

2. The method according to claim 1, wherein the fluid further comprises: a sealing agent.

3. A method for treating a zone of subterranean formation, the method comprising the steps of:
(a) introducing a water-in-oil emulsion into the zone of the formation, wherein the emulsion comprises:
(i) an external oil phase;
(ii) a water-swellable polymer, wherein the water-swellable polymer is selected for not substantially swelling in an aqueous phase having a sufficiently acidic pH; and
(iii) an internal aqueous phase, wherein the aqueous phase comprises acid to make the pH equal to or less than the sufficiently acidic pH; and
(iv) an emulsifier;
wherein the water-in-oil emulsion is at least sufficiently stable under the conditions of introducing to reach the zone of the subterranean formation before breaking; and
(b) allowing or causing the oil-external emulsion to break and the water-swellable polymer to swell in the zone of the formation.

4. The method according to claim 2, wherein the water-swellable polymer: absorbs greater than 10 times its weight of water; and swells to greater than 10 times its volume as it absorbs water.

5. The method according to claim 3, wherein the water-swellable polymer comprises at least one polymer selected from the group consisting of a crosslinked polyacrylamide, a crosslinked polyacrylate, a copolymer of acrylamide and acrylate monomers, a starch backbone grafted with acrylonitrile and acrylate, a polymer of two or more of allylsulfonate, 2-acrylamido-2-methyl-1-propanesulfonic acid, 3-allyloxy-2-hydroxy-1-propane-sulfonic acid, acrylamide, and an acrylic acid monomer, and any combination in any proportion of the foregoing.

6. The method according to claim 5, wherein the crosslinked polyacrylamide comprises a crystalline polymer of crosslinked polyacrylamide.

7. The method according to claim 3, wherein the water-swellable polymer comprises at least one polymer selected from the group consisting of a hydrolyzed polyacrylonitrile, a carboxyalkyl cellulose, a carboxymethyl starch, a salt of carboxymethyl cellulose, a carboxyalkyl polysaccharide, and any combination in any proportion of the foregoing.

8. The method according to claim 3, wherein the emulsion further comprises: a sealing agent.

9. The method according to claim 8, wherein the sealing agent: is greater than 0.01 weight % soluble in water; and forms a three dimensional gel structure in water.

10. The method according to claim 9, wherein the sealing agent comprises a monomer.

11. The method according to claim 9, wherein the sealing agent comprises a polymerizable monomer and a crosslinker for the polymerizable monomer.

12. The method according to claim 3, wherein the emulsifier is selected for stabilizing the internal aqueous phase in the external oil phase.

13. The method according to claim 3, wherein the emulsifier is selected from the group consisting of: fatty alkanol amides and a blend of an amphoteric amine salt, a phosphate ester, an ethoxylated dialkyl phenol, a propylene glycol ether, a carboxylic acid terminated polyamide, an electro-neutral fatty ammonium salt of a fatty acid such as, tallow ammonium salt of coco fatty acid, the coco ammonium salt of oleic fatty acid, the coco ammonium salt of coco fatty acid, and similar, and any combination in any proportion of the foregoing.

14. The method according to claim 3, further comprising the step of introducing an aqueous solution before or after introducing the water-in-oil emulsion of the water-swellable polymer into the zone of the formation.

15. The method according to claim 3, further comprising the step of: after the step of allowing or causing, flowing back fluid from the well.

16. A fluid for placing a water-swellable polymer into a zone of a subterranean formation, the fluid comprising:
(i) an external oil phase;
(ii) a water-swellable polymer, wherein the water-swellable polymer is selected for not substantially swelling in an aqueous phase having a sufficiently acidic pH; and
(iii) an internal aqueous phase, wherein the aqueous phase comprises acid to make the pH equal to or less than the sufficiently acidic pH; and
(iv) an emulsifier.

17. The fluid according to claim 16, wherein the water-swellable polymer: is capable of absorbing greater than 10 times its weight of water and swelling to greater than 10 times its volume as it absorbs water at neutral pH.

18. The fluid according to claim 16, wherein the water-swellable polymer comprises at least one polymer selected from the group consisting of a crosslinked polyacrylamide, a crosslinked polyacrylate, a copolymer of acrylamide and acrylate monomers, a starch backbone grafted with acrylonitrile and acrylate, a polymer of two or more of allylsulfonate, 2-acrylamido-2-methyl-1-propanesulfonic acid, 3-allyloxy-2-hydroxy-1-propane-sulfonic acid, acrylamide, and an acrylic acid monomer, and any combination in any proportion of the foregoing.

19. The fluid according to claim 16, wherein the emulsion further comprises: a sealing agent.

20. The fluid according to claim 19, wherein the sealing agent: is greater than 0.01 weight % soluble in water; and forms a three dimensional gel structure in water.

21. The fluid according to claim 16, wherein the emulsifier is selected for stabilizing the internal aqueous phase in the external oil phase.

22. The fluid according to claim 16, wherein the emulsifier is selected from the group consisting of: fatty alkanol amides and a blend of an amphoteric amine salt, a phosphate ester, an ethoxylated dialkyl phenol, a propylene glycol ether, a carboxylic acid terminated polyamide, an electro-neutral fatty ammonium salt of a fatty acid such as, tallow ammonium salt of coco fatty acid, the coco ammonium salt of oleic fatty acid, the coco ammonium salt of coco fatty acid, and similar, and any combination in any proportion of the foregoing.
